(19) United States
(12) Patent Application Publication
(10) Pub. No.: US 2010/0083000 A1
(43) Pub. Date: Apr. 1, 2010

(54) Fingerprint Sensor Device and System with Verification Token and Methods of Using

(75) Inventor: Ramesh Kesanupalli, San Jose, CA (US)

Correspondence Address: Stevens Law Group, 1754 Technology Drive, Suite #226, San Jose, CA, 95110, US

(73) Assignee: Validity Sensors, Inc., San Jose, CA (US)

(21) Appl. No.: 12/561,186

(22) Filed: Sep. 16, 2009

Related U.S. Application Data
(60) Provisional application No. 61/097,503, filed on Sep. 16, 2008.

(51) Int. Cl. H04L 9/32; G05B 19/00; G06F 21/22

(52) U.S. Cl. 713/186; 340/5.82; 726/7

(57) ABSTRACT

A method and system of verification is provided for sensing a fingerprint. The present invention offers a secure authentication method and system based on a user's fingerprint data to grant the access to information at a remote location. A biometric input corresponding to the fingerprint is provided by a user and the biometric input is than validated. Based on the validation, a token is transmitted to a remote location. The method and system can be further enhanced by additional security comprising receiving a request based on the authentication of the user information and transmitting, to a second remote location, a token based on the biometric input in response to the request.

### RELATED APPLICATIONS

This application claims priority based on U.S. Provisional Patent Application No. 61/097,503, filed on Sep. 16, 2008, entitled “Fingerprint Sensor Device and System with Verification Token and Methods of Using.”

### BACKGROUND OF THE INVENTION

Various methods of authentication have been developed to aid in secure access by users to local devices, user accounts, and other access-sensitive systems. For example, it is common to require a user to input a username and password in order to enter into an online account. Some systems may also require the entry of additional information, such as a mother's maiden name, to further ascertain that the individual providing input is a proper user of the account.

However, such methods of verification are prone to abuse, hacking, and theft. For example, an individual may transmit via e-mail his own username and password for access to a particular account. He may send this information to himself, for his own records, or to a friend, to allow the friend temporary access. However, should another individual gain unpermitted access to the recipient's e-mail account, this individual may then have knowledge of the username and password. There are also many other ways in which a proper user's username and password, or other text-based information, may be retrieved in an unauthorized manner.

Thus, in order to prevent the compromise of account security, it is beneficial to employ the use of biometric data such as fingerprints so as to ascertain the identity of the user requesting access. The requirement of biometric data input serves as a measure of assurance that the individual providing input is the rightful owner of the input data.

Biometric authentication has been utilized within authentication processes to ensure secure access by users to devices. However, in the context of remote transactions, such as consumer e-commerce transactions, enterprise server authentication, and wireless mobile carrier site access, incorporating biometric authentication raises some difficulties.

For example, in order for an existing system to integrate the use of biometrics, this system may require alterations in its infrastructure so as to adapt to the incorporation of biometrics. This dissuades many system owners from implementing the necessary adaptations to move forward with using biometric authentication.

In addition, the validation of input biometric data may require the comparison of that data with previously stored biometric data. In order for input data to be validated so as to provide the user access to a remote site, such as described above, the remote site may be required to store a collection of biometric data. This poses an obstacle to user conformity, as many individuals are not accepting of the storage of their personal data, such as biometric data, in a non-local context.

Hence, it is desirable to have a solution without the above-described disadvantages, to advance the security of online, and remote transactions. As will be seen, the invention provides such a solution in an elegant manner.

### BRIEF DESCRIPTION OF THE DRAWINGS

FIG. 1 illustrates an embodiment of the invention.

FIG. 2 illustrates an embodiment of a sensor device configured according to the invention.

FIG. 3 illustrates an embodiment of the invention whereby a token based on validation of biometric input received from a user is sent in order to seek access to remote data.

FIG. 4 illustrates an embodiment of the invention whereby user information based on the biometric input and a token based on the biometric input may be transmitted to first and second remote locations, respectively.

### DETAILED DESCRIPTION OF THE INVENTION

The invention is directed to devices, systems and methods, comprising sensing a biometric input by a user; validating the biometric input; outputting user information based on the biometric input; receiving a request based on authentication of the user information; and transmitting a token in response to the request based on the biometric input.

The invention is also directed to devices, systems and methods, comprising sensing a biometric input by a user; validating the biometric input; and transmitting a token based on validation of the biometric input.

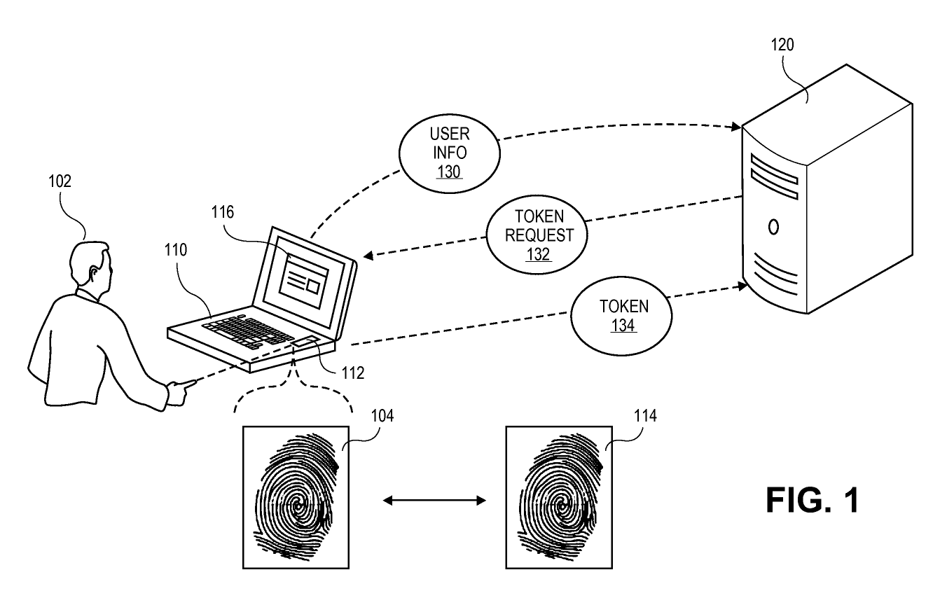

The present invention provides devices, systems and methods by which biometric authentication may be incorporated into existing access verification infrastructures, and in which remote storage of biometric data is not required. As illustrated in FIG. 1, a user 102 may input biometric data, such as but not limited to a fingerprint 104, into a biometric sensor 112 of a local device 110. In order to validate fingerprint 104, local device 110 may compare user fingerprint 104 to locally stored biometric data, such as stored fingerprint 114. This validation process may be performed by either the operating system of local device 110 or the sensor 112 itself, or both.

If user fingerprint 104 is validated successfully, local device 110 may output user information 130 to remote device 120. Remote device 120 may be, for example, a server related to an e-commerce site, a financial institution, wireless carrier, or company data server, amongst various other systems related to secure sites. User information 130 may include, for example, a username, a password, answers to personal or targeted questions, or other identifying information. The user identification may be a unique user ID or a randomly assigned number such as a number generated by a Physical Unclonable Function (PUF). Remote device 120 may, upon receiving user information 130, attempt to authenticate user information 130. If successful, remote device 130 may send to local device 110 a request 132 for a token 134 including, for example, a security key, one-time password, or other dynamically generated token. Local device 110 may then respond to request 132 by transmitting a token 134, so as to gain access to data related to remote device 120. Remote device 120 may then optionally send to local device 110 an indication of successful authentication, and this indication may be reflected in a user interface 116 of local device 110.

In another embodiment of the invention, token 134 may be transmitted to remote device 120 directly after validation of user fingerprint 104, without first outputting user information 130 or receiving request 132. Upon receiving token 134, remote device 120 may authenticate the user 102 based directly on the token 134.

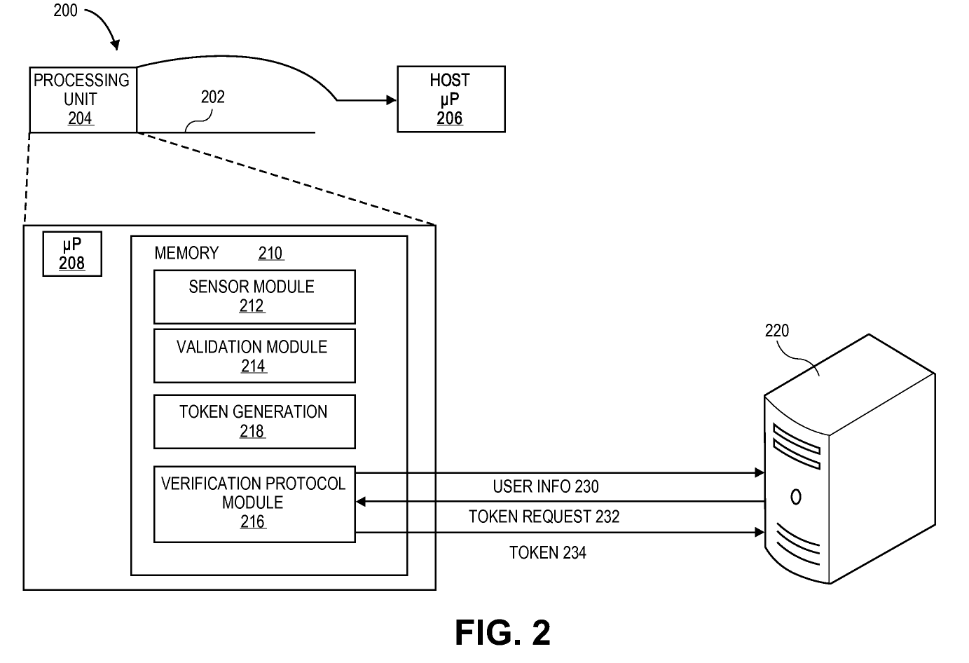

FIG. 2 illustrates an embodiment of a sensor device 200 configured according to the invention. Sensor device 200 may include sensing surface 202 to obtain a biometric input from a user, coupled with processing unit 204, which may be coupled with host microprocessor 206. Processing unit 204 may include, for example, a microprocessor 208 and memory 210. Memory 210 may include, for example, a sensor module 212 configured to process the biometric input. Sensor module 212 may, for example, generate and/or receive signals in response to user input such as pressure applied to the sensing surface 202 by a finger, receive biometric image data from the sensing surface 202, reconstruct the image, or otherwise process the input. Sensor module 212 may transmit the image to another module for verification, such as validation module 214 in processing unit 204, or host microprocessor 206 in a local device coupled with sensor device 200.

Once the biometric input is validated, processing unit 204 may employ verification protocol module 216 to transmit to, for example, a first remote location 220, user information 230 based on the biometric input. Verification protocol module 216 may then receive, from the first remote location 220 or a different location, a request 232 such as for a token, based on authentication of the user information. Verification protocol module 216 may respond by transmitting a token 234 generated by, for example, token generator 218, to the first remote location 220 or a second different remote location. While the preferred embodiment of the current invention directs to four modules associated with the microprocessor 208, there are various combinations that a person with ordinary skill in the field may arrange to achieve the same goal. For example, the sensor module 212 and the validation module 214 may be combined into a single module to process the biometric input and to validating the biometric input. It is also possible that sensor module 212, validation module 214, token generation 218 and verification protocol module 216 can be combined into a single module to process the biometric input, to validating the biometric input, to generate the token and to transmit the token 234 generated by token generator 218, to the first remote location 220 or a second different remote location.

The user information 230, token request 232, and/or token 234 may be transmitted via packets formatted within, for example, processing units of the respective sending devices. Each packet may be generated to include control information and user data, also known as payload. The control information may be placed in headers or trailers, and may include information such as but not limited to source and destination addresses, length/size information, error detection codes, and/or sequencing information. The payload may include, for example, the user information 230, token request 232, and/or token 234, respectively.

Different embodiments are possible given the invention, and those skilled in the art will understand that many applications, examples of these embodiments, and other derivations are possible within the scope of the invention. Some are as follows.

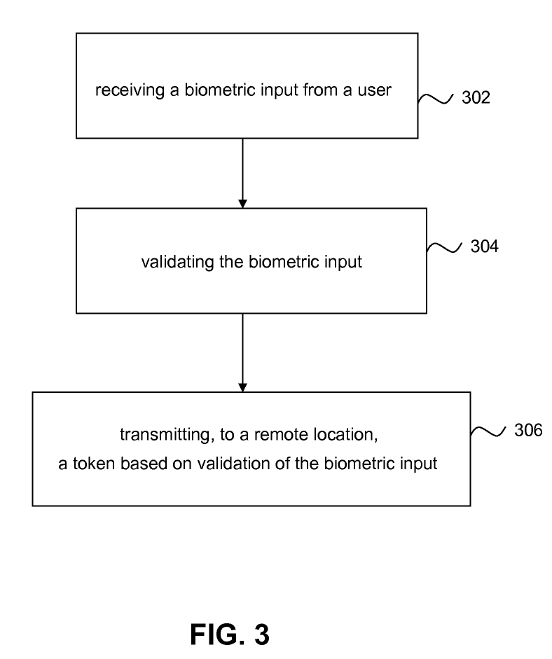

The invention is directed to system and method of receiving a biometric input from a user, validating the biometric input, and transmitting, to a remote location, a token based on validation of the biometric input. The token may or may not include a one-time password, and may or may not be a unique user ID for identifying the user. The unique user ID may be encrypted, and may also be an encrypted PUF output. The method may further include the step of receiving a response indicating authentication of the token. In one embodiment, the token may be sent, in order to seek access to remote data as shown in FIG. 3. The biometric input may be received via a sensor of a local device from a user 302. The validating may be performed 304 by an operating system of the local device. Alternatively, the validating is performed by the sensor. A token based on the biometric input is then transmitted to a remote location 306.

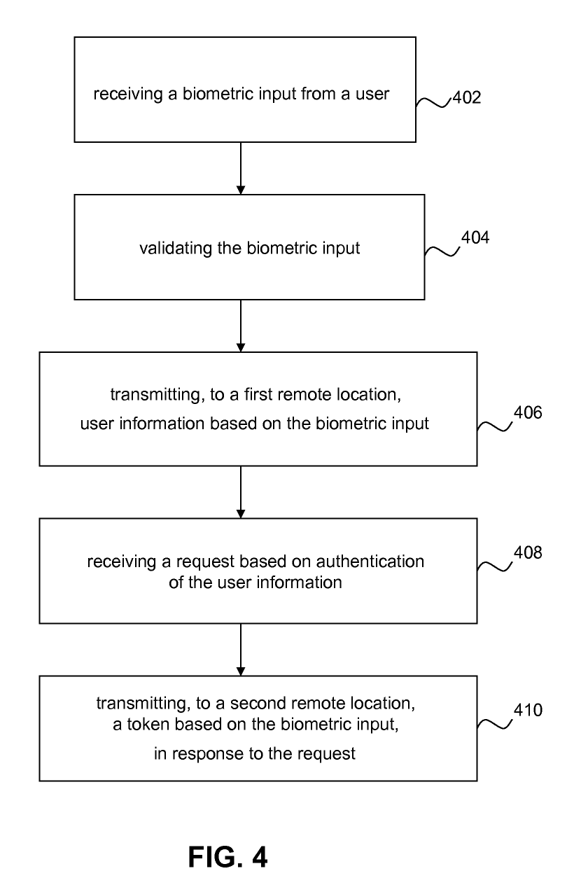

In another embodiment as shown in FIG. 4, a method is provided that includes receiving a biometric input from a user 402, validating the biometric input 404, transmitting user information based on the biometric input to a first remote location 406, receiving a request based on authentication of the user information 408, and transmitting a token based on the biometric input 410, in response to the request to a second remote location. Here, the first remote location and second remote location may be the same location. Alternatively, the first remote location and second remote location are different locations. In one example, one of the first remote location and second remote location may be related to one of the group consisting of a carrier network, an e-commerce site, an enterprise network, and a financial institution. Other variants may exist also. The request may be received from a remote location. As above, the token may include a one-time password. The token may be a unique user ID for identifying the user, and the unique user ID may be encrypted. The unique user ID may be an encrypted PUF output. The method may further include receiving a response indicating authentication of the token. The user information may output, and the token is sent, in order to seek access to remote data. The biometric input may be received via a sensor of a local device. Here, the validating may be performed by an operating system of the local device. Alternatively, the validating may be performed by the sensor.

In another embodiment, a system is provided that includes a sensor configured to receive a biometric input from a user and validate the biometric input. The system further includes a first remote device, wherein the sensor is configured to transmit, to the first remote device, user information based on the biometric input, and the remote device is configured to transmit to the sensor a request based on authentication of the user information. A second remote device is also included, wherein the sensor is configured to transmit, to the second remote device, a token based on the biometric input, in response to the request.

In this system, the first remote location and second remote location may be the same device, or, alternatively, they may be different devices. One of the first remote device and second remote device may be related to one of the group consisting of a carrier network, an e-commerce site, an enterprise network, and a financial institution. The token may include a one-time password, and may be a unique user ID for identifying the user. The unique user ID may be encrypted. The unique user ID may alternatively be an encrypted PUF output. The second remote device may be further configured to transmit a response to the sensor indicating authentication of the token. The sensor may transmit the user information and the token in order to seek access to remote data. The sensor may be coupled with a local device. The validating may be performed by an operating system of the local device, or, alternatively, the validating may be performed by the sensor.

Still further, the invention provides a device in one embodiment that includes a sensing surface for receiving biometric information. The device also includes a processing unit, coupled to the sensing surface, to receive a biometric input from a user via the sensing surface. The processing unit may include a processor such as a microprocessor or other similar device for processing digital data. The device also includes a sensor module configured to receive the biometric input. A verification protocol module is also included that is configured to transmit, to a first remote location, user information based on the biometric input, and to receive a request based on authentication of the user information. Also, a token generator configured to generate a token based on the biometric input, wherein the verification protocol module transmits the token, to a second remote location, in response to the request. The processing unit may further include a validation module configured to validate the biometric input. Here, the first remote location and second remote location may be the same location, or may be different locations. As above, one of the first remote location and second remote location may be related to one of the group consisting of a carrier network, an e-commerce site, an enterprise network, and a financial institution. Also, the request may be received from a remote location, and the token may include a one-time password or other identification. The token may be a unique user ID for identifying the user, and may or may not be encrypted. The unique user ID may be an encrypted PUF output.

The verification protocol module may be further configured to receive a response indicating authentication of the token. The verification protocol module may transmit the user information and the token in order to seek access to remote data. The processing unit may be coupled with a local device. And, an operating system of the local device may be configured to validate the biometric input.

In another example of a device configured according to the invention, a device may include a sensing surface, a processing unit that is coupled to the sensing surface for receiving a biometric input from a user via the sensing surface. The processing unit may include a microprocessor or the like, and the microprocessor may be configured to receive the biometric input, to validate the biometric input, to transmit to a first remote location user information based on the biometric input, to receive a request based on authentication of the user information, and to generate a token based on the biometric input The verification protocol module may be configured to transmit the token to a second remote location in response to the request. As above, the first remote location and second remote location may be in similar, same, or different locations. One of the first remote location and second remote location may be related to one of the group consisting of a carrier network, an e-commerce site, an enterprise network, and a financial institution. The request may be received from a remote location. The token may include a one-time password. The token may be a unique user ID for identifying the user. The unique user ID may be encrypted, and may or may not be an encrypted PUF output. The verification protocol module may be further configured to receive a response indicating authentication of the token. Also, the verification protocol module may transmit the user information and the token in order to seek access to remote data. The processing unit may be coupled with a local device or possibly a remote device. And, an operating system of the local device is configured to validate the biometric input.

The invention may also involve a number of functions to be performed by a computer processor, such as a microprocessor. The microprocessor may be a specialized or dedicated microprocessor that is configured to perform particular tasks according to the invention, by executing machine-readable software code that defines the particular tasks embodied by the invention. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and also possibly computer servers or other devices that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the invention as described herein enable the physical transformation of these memory devices. Accordingly, the invention as described herein is directed to novel and useful systems and methods that, in one or more embodiments, are able to transform the memory device into a different state. The invention is not limited to any particular type of memory device, or any commonly used protocol for storing and retrieving information to and from these memory devices, respectively.

Thus, the invention provides a method for multi-level authentication without the need to transmit biometric data outside of a local device. Furthermore, while the foregoing description has been put forth with reference to particular embodiments of the invention, it will be appreciated that these are only illustrative of the invention and that changes may be made to those embodiments without departing from the principles of the invention as defined by the appended claims.

What is claimed is:

1. A method, comprising:
receiving a biometric input from a user;
validating the biometric input; and
transmitting, to a remote location, a token based on validation of the biometric input.

2. The method of claim 1, wherein the token includes a one-time password.

3. The method of claim 1, wherein the token is a unique user ID for identifying the user.

4. The method of claim 1, wherein the unique user ID is encrypted.

5. The method of claim 1, wherein the unique user ID is an encrypted PUF output.

6. The method of claim 1, further comprising:
receiving a response indicating authentication of the token.

7. The method of claim 1, wherein the token is sent, in order to seek access to remote data.

8. The method of claim 1, wherein the biometric input is received via a sensor of a local device.

9. The method of claim 8, wherein the validating is performed by an operating system of the local device.

10. The method of claim 8, wherein the validating is performed by the sensor.

11. A method, comprising:
receiving a biometric input from a user;
validating the biometric input;
transmitting, to a first remote location, user information based on the biometric input;
receiving a request based on authentication of the user information; and
transmitting, to a second remote location, a token based on the biometric input, in response to the request.

12. The method of claim 11, wherein the first remote location and second remote location are the same location.

13. The method of claim 11, wherein the first remote location and second remote location are different locations.

14. The method of claim 11, wherein one of the first remote location and second remote location is related to one of the group consisting of a carrier network, an e-commerce site, an enterprise network, and a financial institution.

15. The method of claim 11, wherein the request is received from a remote location.

16. The method of claim 11, wherein the token includes a one-time password.

17. The method of claim 11, wherein the token is a unique user ID for identifying the user.

18. The method of claim 17, wherein the unique user ID is encrypted.

19. The method of claim 17, wherein the unique user ID is an encrypted PUF output.

20. The method of claim 11, further comprising:
receiving a response indicating authentication of the token.

21. The method of claim 11, wherein the user information is output, and the token is sent, in order to seek access to remote data.

22. The method of claim 11, wherein the biometric input is received via a sensor of a local device.

23. The method of claim 22, wherein the validating is performed by an operating system of the local device.

24. The method of claim 22, wherein the validating is performed by the sensor.

25. A method, comprising:
receiving a biometric fingerprint data input from a user;
validating the biometric input; and
transmitting, to a remote location, a token based on validation of the biometric fingerprint data input.

26. A system, comprising:
a sensor configured to receive a biometric input from a user and validate the biometric input;
a first remote device, wherein the sensor is configured to transmit, to the first remote device, user information based on the biometric input, and the remote device is configured to transmit to the sensor a request based on authentication of the user information; and
a second remote device, wherein the sensor is configured to transmit, to the second remote device, a token based on the biometric input, in response to the request.

27. The system of claim 26, wherein the first remote location and second remote location are the same device.

28. The system of claim 26, wherein the first remote location and second remote location are different devices.

29. The system of claim 26, wherein one of the first remote device and second remote device is related to one of the group consisting of a carrier network, an e-commerce site, an enterprise network, and a financial institution.

30. The system of claim 26, wherein the token includes a one-time password.

31. The system of claim 26, wherein the token is a unique user ID for identifying the user.

32. The system of claim 31, wherein the unique user ID is encrypted.

33. The system of claim 31, wherein the unique user ID is an encrypted PUF output.

34. The system of claim 26, wherein the second remote device is further configured to transmit a response to the sensor indicating authentication of the token.

35. The system of claim 26, wherein the sensor transmits the user information and the token in order to seek access to remote data.

36. The system of claim 26, wherein the sensor is coupled with a local device.

37. The system of claim 36, wherein the validating is performed by an operating system of the local device.

38. The system of claim 26, wherein the validating is performed by the sensor.
